(19) United States
(12) Patent Application Publication
(10) Pub. No.: US 2007/0063582 A1
(43) Pub. Date: Mar. 22, 2007

(54) Trailer isolator assembly

(76) Inventor: Barry John Bryar, Victoria (AU)

Correspondence Address: EDWIN D. SCHINDLER, FIVE HIRSCH AVENUE, P.O. BOX 966, CORAM, NY, 11727-0966, US

(21) Appl. No.: 10/583,484

(22) PCT Filed: Dec. 9, 2004
(86) PCT No.: PCT/AU04/01730

§ 371 Date: Jun. 15, 2006

(30) Foreign Application Priority Data
Dec. 15, 2003 (AU) 2003906900

(51) Int. Cl. B60T 7/20

(52) U.S. Cl. 303/123

(57) ABSTRACT

A trailer isolator assembly includes a mechanically operable valve that is connected into a trailer compressed air supply, so the valve permits compressed air to pass through the supply line to a braking system when the valve is in a closed state and, in an open state, the valve causes air in the supply line to be exhausted from the valve through an exhaust line.

### AREA OF THE INVENTION

This invention relates to anti theft devices for vehicles and in particular to such devices when used on trucks and trailers and the like. In particular the invention is a means of immobilising a truck or trailer by utilising its air brake system. For ease of description the invention will be described here in terms of immobilising a trailer.

### BACKGROUND TO THE INVENTION

A typical air brake for tractors and trailers uses two pneumatic circuits in its braking system. When braking is being effected air pressure in a compressed air supply line is lowered such that air is drawn from an auxiliary reservoir of compressed air through a central valve which is connected to a spring loaded brake cylinder containing a piston which in turn acts on a brake rod and brake shoe to effect braking.

When a trailer is disconnected its brakes are normally actuated. When a trailer is connected to a tractor or truck or the like compressed air passes through the supply line to disengage the brakes.

While this is an effective safety development which provides an air brake system which is locked when a trailer is detached, the ability of air brakes to be controlled by connection to a tractor's braking system makes security problematic in that, once a trailer is connected to a truck or the like, the braking is deactivated.

### OUTLINE OF THE INVENTION

It is an object of this invention to provide a means whereby a trailer, the brakes of which are on when it is detached from a truck or the like remains in this state until someone rightfully authorised to move the trailer does so. For the purposes of this description of the invention the term trailer is taken to broadly encompass all trailable vehicles which have an air braking system.

The invention is a trailer isolator assembly which includes a mechanically operable valve means which is connected into a trailer compressed air supply line such that in a closed state the valve permits compressed air to pass through the supply line to a braking system and in an open state causes air in the supply line to be exhausted from the valve means through an exhaust line.

It is preferred that in its open state the valve of the trailer isolator assembly dumps all air in the supply line as well as air in storage tanks associated with the trailer. It may also be preferred that the assembly cause air storage tanks in any truck which is subsequently connected to the trailer to be discharged also.

It is also preferred that a horn be provided in association with the exhaust line such that exhaust air can pass through it. It is further preferred that actuation of the discharge to the horn be controlled by switch means.

In order that the invention may be more readily understood an embodiment of it will be described herein by way of non limiting example with reference to the accompanying drawings

### BRIEF DESCRIPTION OF THE DRAWING FIGURES

FIG. 1 is a schematic diagram showing the location of the trailer isolator in an air brake system;

FIG. 2 is a schematic diagram of the interior of the trailer isolator;

FIG. 3 shows the exterior of the trailer isolator;

FIG. 4 shows the trailer isolator with its door partially open such that the lever position is shown;

### BRIEF DESCRIPTION OF THE EMBODIMENT OF THE INVENTION

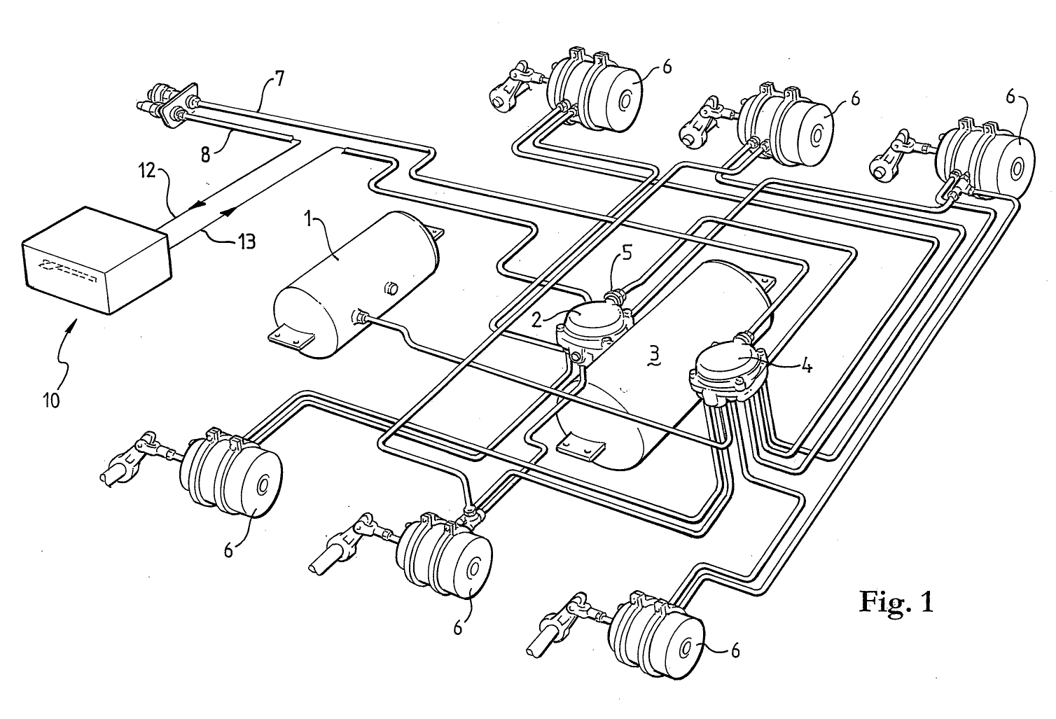

In the embodiment of the invention described here the trailer isolator 10 connects into the compressed air supply line 8 of an air brake system as shown in FIG. 1. This configuration is preferred as it provides for a simple anti theft device whereas use of the control line 7 as well, while possible, unnecessarily complicates the operation of the device.

The air brake system shown is quite standard and includes a service reservoir 1, valve 2, service reservoir 3, relay valve 4, anti-compound valve 5 and spring brakes 6.

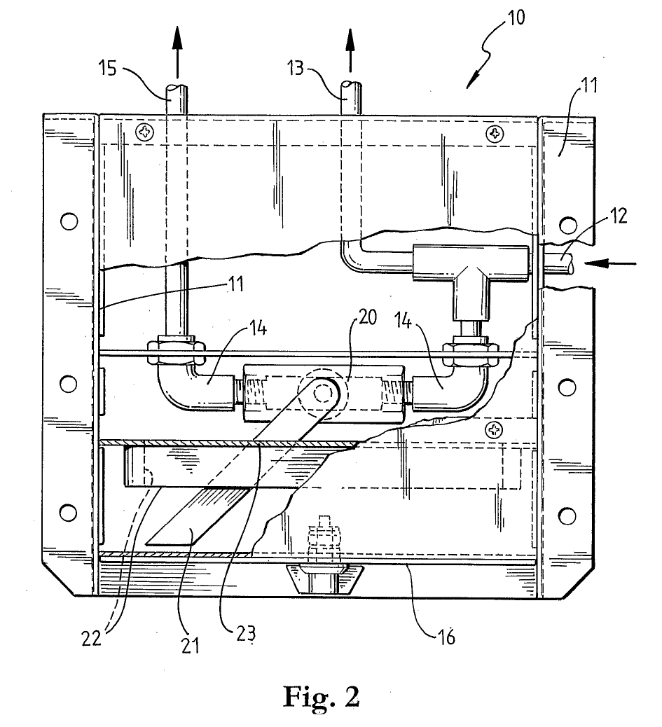

The trailer isolator of the invention is shown in FIGS. 2, 3 and 4 and includes a box housing 1 1 having a front opening door 16 which provides access to lever 21 which operates ball valve 20. The arrangement is such that when the lever 21 is in a first closed position air from supply line 8 enters the isolator at 12 and passes through a tee joint to the output pressure line 13 and the isolator has no effect on the normal operation of the air brakes.

When the trailer is to be parked an operator can manually move arm 21 within an aperture 22 in interior wall 23 to an opposing side of the isolator such that the ball valve 20 is in an open position. Compressed air in the supply line then passes through the tee join through elbow 14 and ball valve 20 to adjacent elbow 14 to exhaust through exhaust line 15.

This decrease in pressure in the supply line causes the brakes to be on and this situation is maintained by the operator simply closing and locking the door to hold the lever in the open position. This exhausting of the air in the supply line also acts to exhaust air in storage tanks associated with the trailer.

Should a truck be hooked up to the trailer while the trailer isolator is activated then its compressed air supply would also be exhausted as shown above.

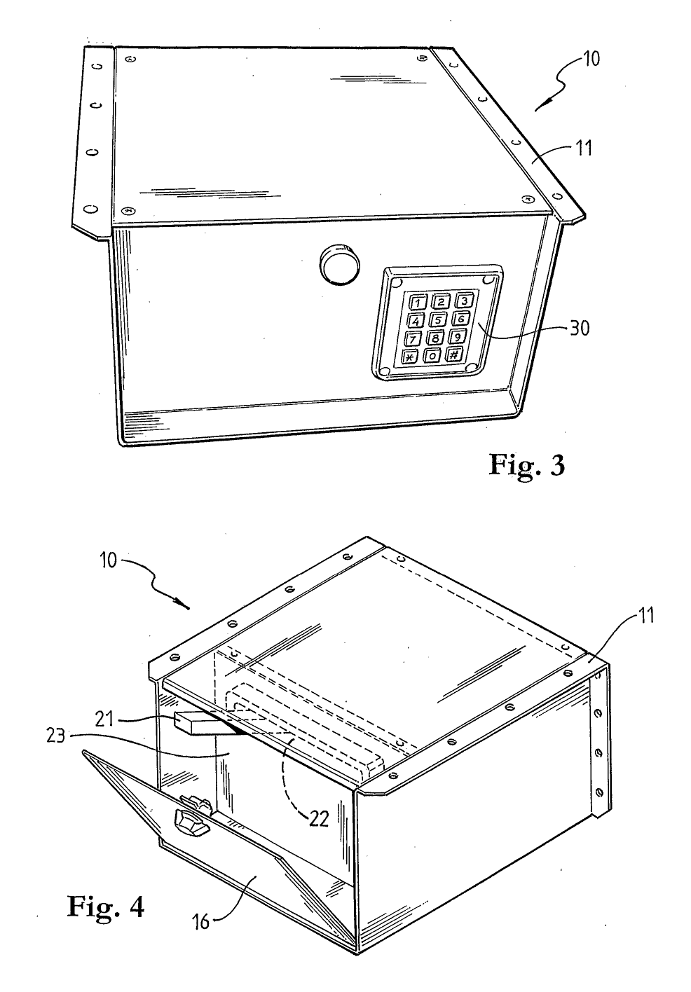

In order to move a trailer fitted with the isolator it is necessary to deactivate the isolator by opening the door with the appropriate key and physically closing the ball valve with the lever. In another embodiment of the invention as shown in FIG. 3 the key is replaced by a numeric key pad. By this means the problem of managing a large number of different keys is removed.

The invention therefore provides a simple means diverting the air flow in the air brake supply line thereby maintaining the brakes of the trailer in an On position. While we have described here an air flow diversion using a ball valve any appropriate valve could be used as could any preferred locking mechanism. It is however preferred that the trailer isolator be housed in a box device which is fitted into a trailer brake system such that it cannot be readily removed. This simple lever operated mechanism which is held in position by a locked door cannot be readily accessed by a would be thief.

Other features of the invention include the option of having a horn or siren device which is activated by the exhaust air. It is preferred that this option be selected by switch or other means and be effected by the operator so that the horn only operates when an attempt to pass air to the supply line occurs. Of course once this device is activated any attempt to connect the air system of a truck to the trailer results in the horn operating.

It is envisaged that as many trailers are fitted with GPS systems that where the battery activated keypad embodiment of the invention is selected that the GPS system could be designed to trigger a signal which in turn triggers an alarm at a base station when abnormal movement is detected. This feature is particularly useful where an operator has neglected to arm the isolator when unhitching a trailer as it enables a stolen trailer to be detected and located.

It is further envisaged that in this situation the GPS signal could be used to remotely activate the valve. Any appropriate means may be used however it is envisaged that the compressed air could be used to activate the lever such that it pressed on the isolator lid causing a signal to be sent to the digitally operated lock to unlock the isolator door and the lever be forced into the valve open position. Alternatively the activation means may be a motor driven screw which passes through a captive nut on the lever.

The GPS signal may also be used to change the code for the keypad on some periodic basis for added security. A driver would then be able to obtain the current code from the relevant base station.

Any number of these features can be included in the invention and it is envisaged that other embodiments of the invention will exhibit any number of and any combination of the features of those previously described and whilst we have described herein one specific embodiment of the invention it is to be understood that variations and modifications in this can be made without departing from the spirit and scope thereof.

1-9. (canceled)

10. A trailer isolator assembly, comprising:
a valve connected to a trailer compressed air supply line, said valve including:
means for permitting passage of compressed air through said trailer compressed air supply line to a braking system when said valve is in a closed state; and,
means for exhausting air present in said compressed air supply line from said valve through an exhaust line when said valve is in an open state.

11. The trailer isolator assembly according to claim 10, wherein said valve further includes means for exhausting air from any trailer air storage tanks when said valve is in said open state.

12. The trailer isolator assembly according to claim 10, wherein said valve further comprises means for exhausting air to a horn when said valve is in said open state.

13. The trailer isolator assembly according to claim 10, wherein said valve is a ball valve.

14. The trailer isolator assembly according to claim 10, further comprising a housing for said valve, said housing being connected to a trailer air brake system and accessible via a lockable door.

15. The trailer isolator assembly according to claim 14, wherein said housing includes a lever for operating said valve.

16. The trailer isolator assembly according to claim 14, wherein said housing includes a keypad for operating said lockable door.

17. The trailer isolator assembly according to claim 10, further comprising a GPS signal from a trailer for identifying location of the trailer.

18. The trailer isolator assembly according to claim 10, further comprising means for remotely operating said means for opening said valve.

19. The trailer isolator assembly according to claim 18, wherein said means for remotely operating means for opening said valve includes a GPS signal that locates a trailer having said trailer isolator assembly and instructs said means for remotely operating said means for opening said valve to open said valve.
